(19) United States
(12) Patent Application Publication
(10) Pub. No.: US 2013/0262023 A1
(43) Pub. Date: Oct. 3, 2013

(54) METHOD FOR ESTIMATING AN OPERATIONAL PARAMETER OF A MOTOR

(71) Applicants: Rong-Ching Wu, Kaohsiung City (TW); Jiun-Huei Ho, Kaohsiung City (TW); Chun-Wei Tseng, Kaohsiung City (TW); Chiung-Chang Hsieh, Kaohsiung City (TW)

(72) Inventors: Rong-Ching Wu, Kaohsiung City (TW); Jiun-Huei Ho, Kaohsiung City (TW); Chun-Wei Tseng, Kaohsiung City (TW); Chiung-Chang Hsieh, Kaohsiung City (TW)

(73) Assignee: I SHOU UNIVERSITY, Kaohsiung City (TW)

(21) Appl. No.: 13/430,990

(22) Filed: Mar. 27, 2012

(51) Int. Cl. G06F 15/00; G01P 3/00

(52) U.S. Cl. 702/145; 702/182

(57) ABSTRACT

A method for estimating an operational parameter of a motor is to be implemented by an estimating device. In the method, the estimating device is configured to: receive an acoustic signal attributed to operation of the motor; process the acoustic signal to obtain a plurality of sample points in the frequency domain, each of which has a frequency and a corresponding amplitude; compute an estimated peak frequency using a centroid method based upon the frequencies and the amplitudes; from a plurality of peak frequencies and a plurality of known values of the operational parameter corresponding respectively to the peak frequencies, select a part of the peak frequencies approximate to the estimated peak frequency and a corresponding part of the known values of the operational parameter; and compute an estimated value of the operational parameter based upon the peak frequencies and the known values of the operational parameter.

### BACKGROUND OF THE INVENTION

1. Field of the Invention

The present invention relates to a method for estimating an operational parameter of a motor, more particularly to a method for estimating a rotation speed of a motor and an input power provided to the motor.

2. Description of the Related Art

Conventional methods for measuring a rotation speed of a motor include stroboscopic speed measurement, frequency-type speed measurement, voltage-type speed measurement, etc. These methods have the following drawbacks.

First, a conventional tachometer for measuring a rotation speed of a rotating machine (such as a motor) using the frequency-type speed measurement or the voltage-type speed measurement has to be coupled to the rotating mechanism. Regarding configuration of a motor, an axle of the motor is generally disposed within the motor, and it is required to disassemble the motor for measuring the rotation speed of the motor. In the case of the motor having a sealed housing, the foregoing conventional tachometer is unsuited to measure the rotation speed of the motor.

Regarding a stroboscopic tachometer, an additional component is attached to the motor such that the practicality of the stroboscopic tachometer is relatively reduced. Further, some types of the stroboscopic tachometer require a reflecting tape stuck on the axle of the motor. After long-term operation of the motor, the reflecting tape may become dirty and it is impractical to stop operation of the motor for the purpose of cleaning the reflecting tape. Thus, the rotation speed of the motor measured by the stroboscopic tachometer may become relatively inaccurate as the reflecting tape becomes more and more dirty.

Moreover, use of the conventional methods for measuring the rotation speed of the motor is limited, that is to say, the conventional methods can be only used for analysis of certain types of motor faults but not for analysis of various types of complex faults of the motor.

Therefore, there has been proposed a method involving use of an acoustic signal attributed to operation of a motor for estimating a rotation speed of a motor. Since any machine will generate an acoustic signal during operation and the acoustic signal can be obtained through air as a medium, the method involving use of an acoustic signal can facilitate the measurement of the rotation speed of the motor in some cases where the conventional methods are unsuitable or even unable to be used for the measurement of the rotation speed. Moreover, since the acoustic signal is generated inherently during operation of the rotating machine (i.e., the motor), it can be detected without any additional component attached to the motor.

Currently, the acoustic signal, magnetic flux and vibration are considered as useful information for motor fault diagnos is. The acoustic signal can be transformed using Fast Fourier Transform, and thus can be used for analysis of various types of the motor faults. Therefore, by detecting the acoustic signal of the motor, not only the estimation of the rotation speed of the motor but also operation condition and fault detection of the motor can be achieved.

In addition, a frequency band in a spectrum of the acoustic signal gently responds to the rotation speed of the motor so that the acoustic signal can be used as well for detection of the operation condition and the fault of the motor. FIG. 1 shows acoustic band shift phenomenon attributed to different rotation speeds of a motor (i.e., 1550 rpm, 1600 rpm and 1650 rpm, respectively). It can be seen from FIG. 1 that the frequency band in the spectrum varies gently and continuously with respect to the rotation speeds.

Rong-Ching Wu et al. proposed a conventional method for estimating the rotation speed of the motor using the acoustic signal in “Detection of Induction Motor Operation Condition by Acoustic Signal,” INDIN 2010, Osaka, Japan, July 2010, pages 792-797. Referring to FIG. 2, the conventional method includes a look-up table establishment procedure (A1) and a rotation speed estimation procedure (A2).

In the look-up table establishment procedure (A1), a plurality of known rotation speeds and a plurality of acoustic signals are received in step (A11). Each of the known rotation speeds is pre-detected during operation of the motor, and each of the acoustic signals corresponds to a respective one of the known rotation speeds.

In step (A12), each of the acoustic signals is transformed into a spectrum using Fast Fourier Transform.

In step (A13), a particular bandwidth that covers a frequency corresponding to the greatest amplitude in the spectrum of each of the acoustic signals is analyzed. In particular, a peak frequency of each of the acoustic signals can be obtained using a second-order polynomial equation based upon frequencies and corresponding amplitudes within the particular bandwidth. Since the second-order polynomial equation and computation of the peak frequency have been described in “Detection of Induction Motor Operation Condition by Acoustic Signal,” details thereof will be omitted herein for the sake of brevity.

In step (A14), a look-up table is established based upon the known rotation speeds and the peak frequencies corresponding to the known rotation speeds, respectively. The look-up table indicates the relationship between the peak frequencies and the known rotation speeds.

In the rotation speed estimation procedure (A2), an acoustic signal attributed to operation of the motor is received in step (A21). Further, the acoustic signal is processed to compute an estimated peak frequency corresponding thereto. The computation of the estimated peak frequency is similar to the computation in steps (A11) to (A13), and details thereof will be omitted herein for the sake of brevity.

In step (A22), a part of the peak frequencies approximate to the estimated peak frequency and a corresponding part of the known rotation speeds are selected from the look-up table established in step (A14). Then, an estimated rotation speed of the motor is computed using Lagrange interpolation based upon the peak frequencies and the known rotation speeds selected in this step.

FIG. 3 shows a relationship between the actual frequency and the estimated peak frequency obtained using the second-order polynomial equation. It can be appreciated that there is a significant error between the actual frequency and the estimated peak frequency obtained using the second-order polynomial equation. As a result, the estimated rotation speed obtained based upon the estimated peak frequency may be inaccurate.

### SUMMARY OF THE INVENTION

Therefore, an object of the present invention is to provide a relatively accurate method for estimating an operation parameter (such as a rotation speed) of a motor.

Accordingly, a method of this invention is provided for estimating an operational parameter of a motor. The method is to be implemented by an estimating device, and comprises the following steps of:

a) configuring the estimating device to receive an acoustic signal attributed to operation of the motor;

b) configuring the estimating device to process the acoustic signal to obtain a plurality of sample points in the frequency domain, each of which has a frequency and an amplitude corresponding to the frequency;

c) configuring the estimating device to compute an estimated peak frequency using a centroid method based upon the frequency and the amplitude of each of the sample points in the frequency domain obtained in step b);

d) from a plurality of peak frequencies and a plurality of known values of the operational parameter of the motor that correspond respectively to the peak frequencies, configuring the estimating device to select a part of the peak frequencies approximate to the estimated peak frequency and a corresponding part of the known values of the operational parameter; and

e) configuring the estimating device to compute an estimated value of the operational parameter of the motor using interpolation based upon the peak frequencies and the known values of the operational parameter selected in step d).

According to another aspect, there is provided an estimating device for estimating an operational parameter of a motor. The estimating device comprises a memory unit and a processing unit electrically connected to the memory unit.

The memory unit stores a look-up table that contains a plurality of peak frequencies and a plurality of known values of the operational parameter of the motor corresponding to the peak frequencies, respectively. The processing unit is operable to implement an estimation method including the following steps of:

i) receiving an acoustic signal attributed to operation of the motor;

ii) processing the acoustic signal to obtain a plurality of sample points in the frequency domain, each of which has a frequency and an amplitude corresponding to the frequency;

iii) computing an estimated peak frequency using a centroid method based upon the frequency and the amplitude of each of the sample points in the frequency domain obtained in step ii);

iv) from the look-up table stored in the memory unit, selecting a part of the peak frequencies approximate to the estimated peak frequency and a corresponding part of the known values of the operational parameter; and

v) computing an estimated value of the operational parameter of the motor using interpolation based upon the peak frequencies and the known values of the operational parameter selected in step iv).

### BRIEF DESCRIPTION OF THE DRAWINGS

Other features and advantages of the present invention will become apparent in the following detailed description of the preferred embodiment with reference to the accompanying drawings, of which:

FIG. 1 is a plot illustrating variation of a frequency band in a spectrum of an acoustic signal with respect to different rotation speeds;

FIG. 2 is a flow chart of a conventional method for estimating a rotation speed of a motor using the acoustic signal;

FIG. 3 is a plot illustrating a relationship between actual frequencies and estimated peak frequencies obtained using a second-order polynomial equation;

FIG. 4 is a block diagram of a preferred embodiment of an estimating device for estimating an operational parameter of a motor according to the present invention;

FIG. 5 is a flow chart of a look-up table establishment procedure of a method for estimating the rotation speed of the motor implemented using the estimating device of the preferred embodiment;

FIG. 6 is a plot illustrating a target bandwidth that covers a frequency corresponding to the greatest amplitude in a spectrum;

FIG. 7 is a plot illustrating an exemplary set of reference sample points within the target bandwidth;

FIG. 8 is a plot illustrating another exemplary set of reference sample points within the target bandwidth;

FIG. 9 is a plot illustrating a relationship between actual frequencies and estimated peak frequencies obtained using a centroid method;

FIG. 10 shows a first look-up table containing a plurality of known values of the rotation speed and a plurality of peak frequencies corresponding to the known values of the rotation speeds;

FIG. 11 is a flow chart of a rotation speed estimation procedure of the method implemented using the estimating device of the preferred embodiment;

FIG. 12 is a plot illustrating a part of the peak frequencies approximate to the estimated peak frequency and a corresponding part of the known values of the operational parameter;

FIG. 13 is a plot illustrating a relationship between the estimated peak frequency and the rotation speed;

FIG. 14 is a flow chart of a method for estimating the input power provided to the motor; and

FIG. 15 is a plot illustrating a relationship between the estimated peak frequency and the input power.

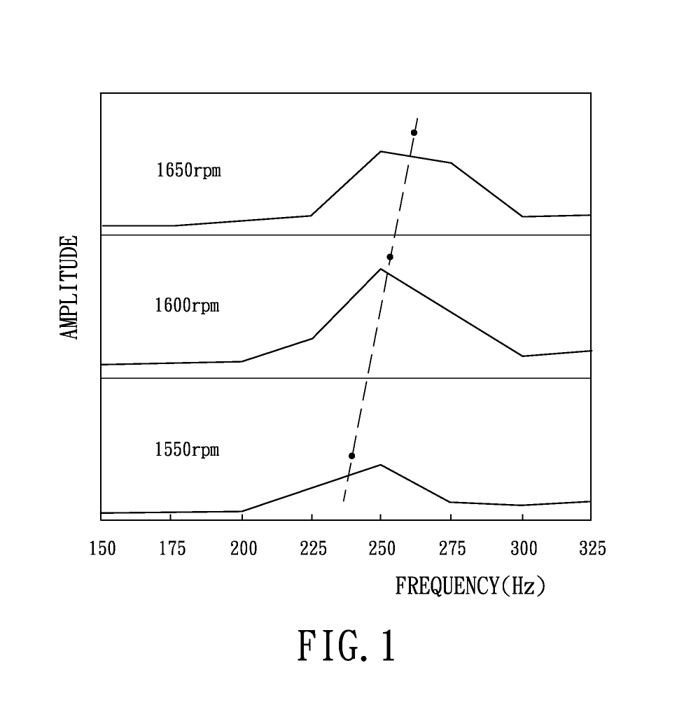

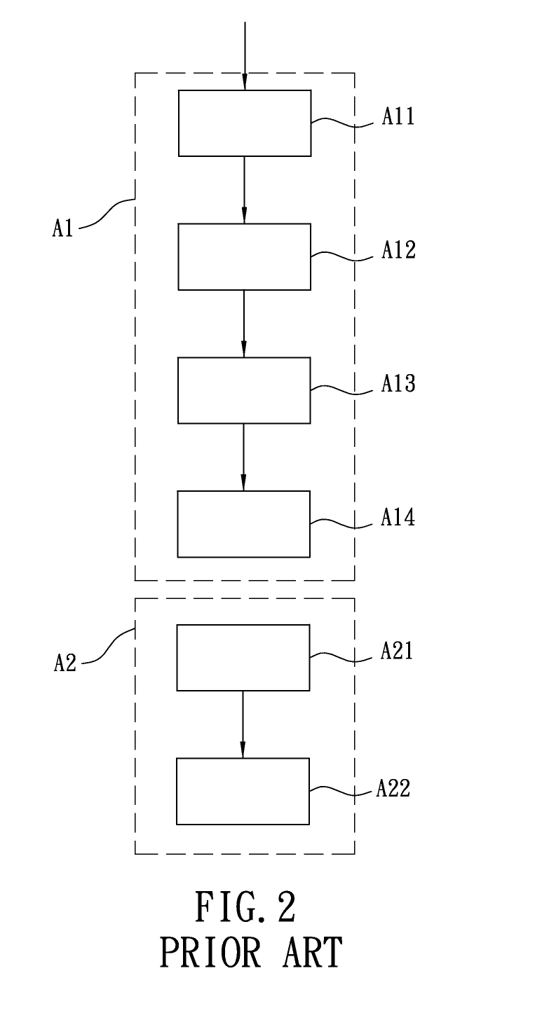

### DETAILED DESCRIPTION OF THE PREFERRED EMBODIMENT

Referring to FIG. 4, a preferred embodiment of an estimating device 1 according to this invention is configured to estimate an operational parameter of a motor 12. The estimating device 1 includes a memory unit 10 and a processing unit 11 electrically connected to the memory unit 10. For example, the operational parameter is, but not limited to, a rotation speed of the motor 12 or an input power provided to the motor 12.

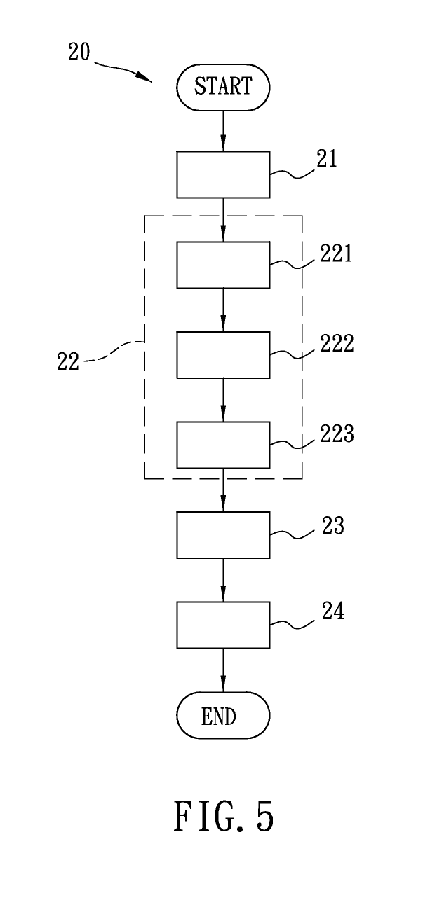

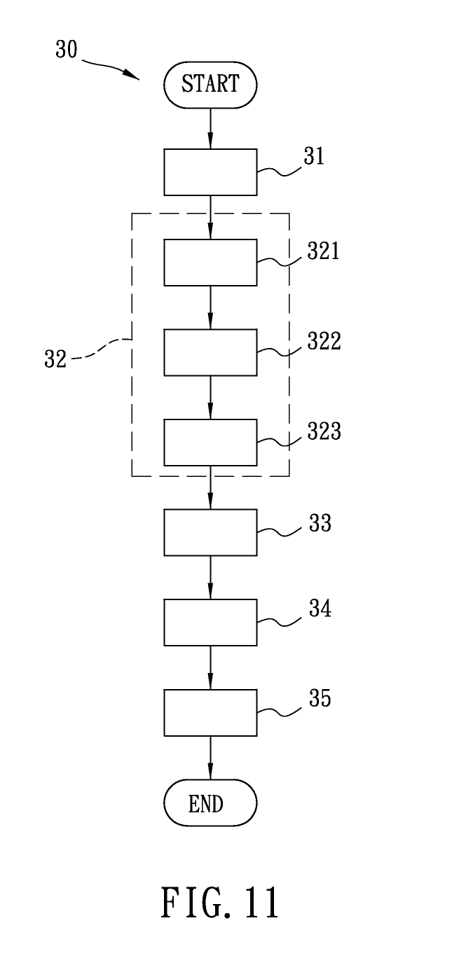

The estimating device 1 is operable to implement a method for estimating the rotation speed of the motor 12. The method includes a look-up table establishment procedure 20 as shown in FIG. 5, and a rotation speed estimation procedure 30 as shown in FIG. 11.

In this embodiment, the estimating device 1 is electrically connected to a storage medium (not shown) storing a plurality of known values of the rotation speeds of the motor 12 and a plurality of reference acoustic signals that correspond to the known values of the rotation speeds, respectively. The known values of the rotation speeds stored in the storage medium are obtained by detecting the motor 12 using a tachometer (not shown) during operation of the motor 12. Each of the reference acoustic signals is attributed to operation of the motor 12 under a respective one of the rotation speeds. The processing unit 11 of the estimating device 1 is able to access the storage medium so as to obtain and process the reference acoustic signals and the known values of the rotation speeds.

During the look-up table establishment procedure 20, the processing unit 11 is operable to receive the reference acoustic signals and the known values of the rotation speeds of the motor 12 from the storage medium in step 21.

In step 22, the processing unit 11 is operable to process the reference acoustic signals to obtain plural sets of reference sample points in the frequency domain, respectively. Each of the reference sample points in each of the sets has a frequency and an amplitude corresponding to the frequency. In particular, step 22 includes the following sub-steps 221-223.

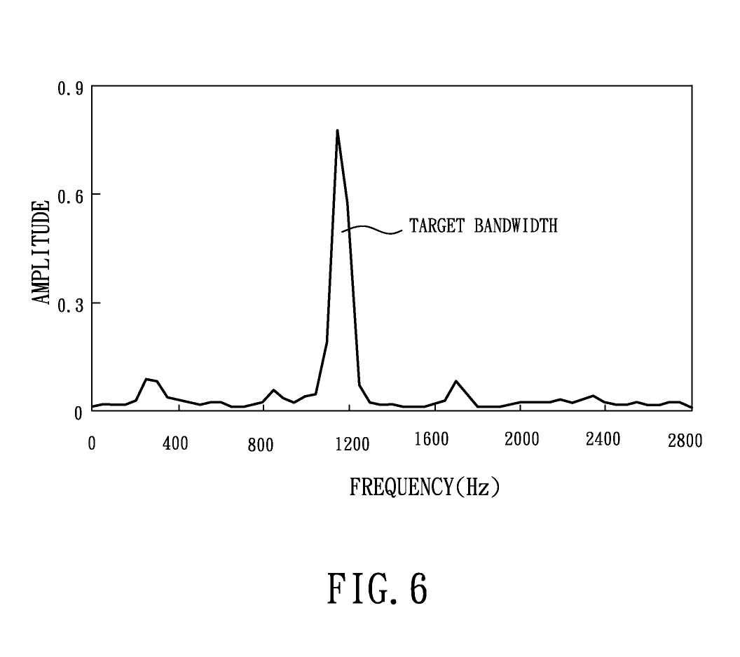

In sub-step 221, the processing unit 11 is operable to sample each of the reference acoustic signals at a predetermined sampling rate so as to obtain a set of sample data in the time domain. In sub-step 222, the processing unit 11 is operable to transform the set of sample data in the time domain to a spectrum that has a plurality of initial sample points in the frequency domain using Fast Fourier Transform (FFT). Then, in sub-step 223, the processing unit 11 is operable to select at least a part of the initial sample points within a target bandwidth that covers a frequency corresponding to the greatest amplitude in the spectrum (see FIG. 6) as a respective one of the sets of the reference sample points.

Then, in step 23, the processing unit 11 is operable to compute a plurality of peak frequencies using a centroid method based upon the sets of the reference sample points obtained in step 22, respectively. In particular, the processing unit 11 is configured to compute each of the peak frequencies corresponding to a respective one of the reference acoustic signals based upon Equation (1) or (2).

$$\begin{matrix}{f}_{y} = \frac{{\sum }_{i = - 0.5 g + 1}^{0.5 g} ( {A}_{P + i} ) ( {f}_{P + i} )}{{\sum }_{i = - 0.5 g + 1}^{0.5 g} {A}_{P + i}} , ɛ = 1 & ( 1 ) \\ {f}_{y} = \frac{{\sum }_{i = - 0.5 g}^{0.5 g + 1} ( {A}_{P + i} ) ( {f}_{P + i} )}{{\sum }_{i = - 0.5 g}^{0.5 g + 1} {A}_{P + i}} , ɛ = - 1 & ( 2 )\end{matrix}$$

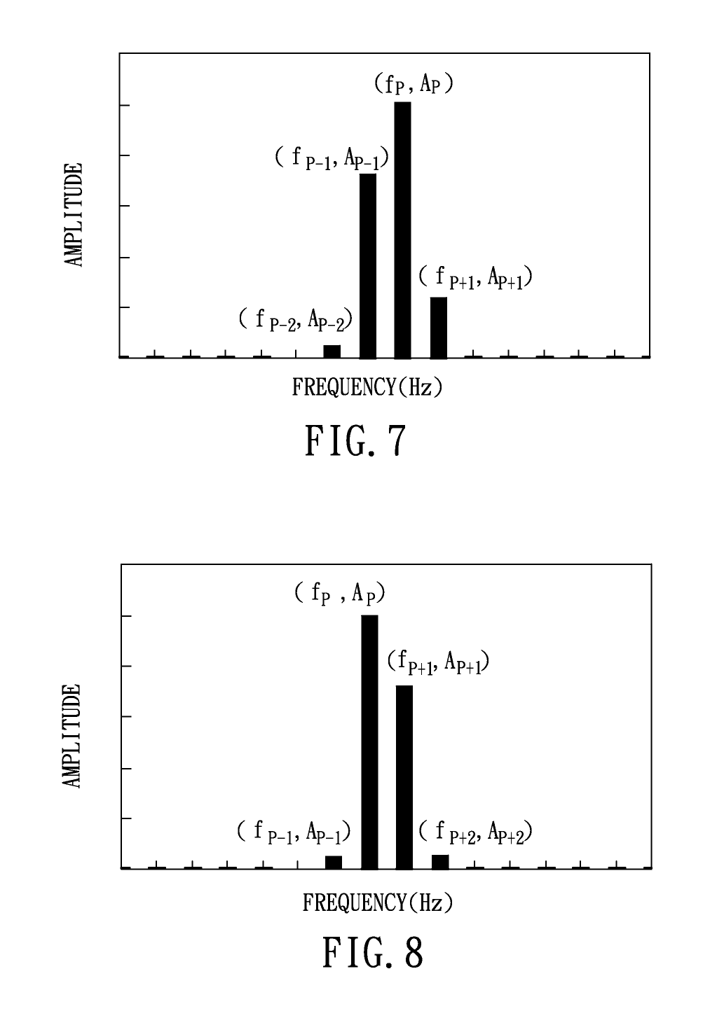

In Equations (1) and (2), f_{y} is the peak frequency, g is a number of the reference sample points in each of the sets in the frequency domain obtained in step 22, P is an index indicating one of the reference sample points that is associated with the greatest amplitude, A_{P+i} is the amplitude of one of the reference sample points that corresponds to the index P+i, f_{P+i} is the frequency of one of the reference sample points that corresponds to the index P+i, and & is an index that is equal to 1 when A_{P-1}<A_{P-1} and that is equal to −1 when A_{P-1}>A_{P+1}. For each of the sets of the reference sample points, since the reference sample points converge to said one of the reference sample points (P) associated with the greatest amplitude, the reference sample points adjacent to the sample point (P) have relatively greater amplitudes. Thus, it can be assumed that the second greatest amplitude is associated with one of the reference sample points associated with the index P+ε. For example, when A_{P-1}1>A_{P+1} (i.e., ε=−1) and the number of the reference sample points in each of the sets is equal to 4 (g=4), the reference sample points are illustrated in FIG. 7. As another example, when A_{P-1}<A_{P+1} (i.e., ε=1) and the number of the reference sample points in each of the sets is equal to 4 (g=4), the reference sample points are illustrated in FIG. 8.

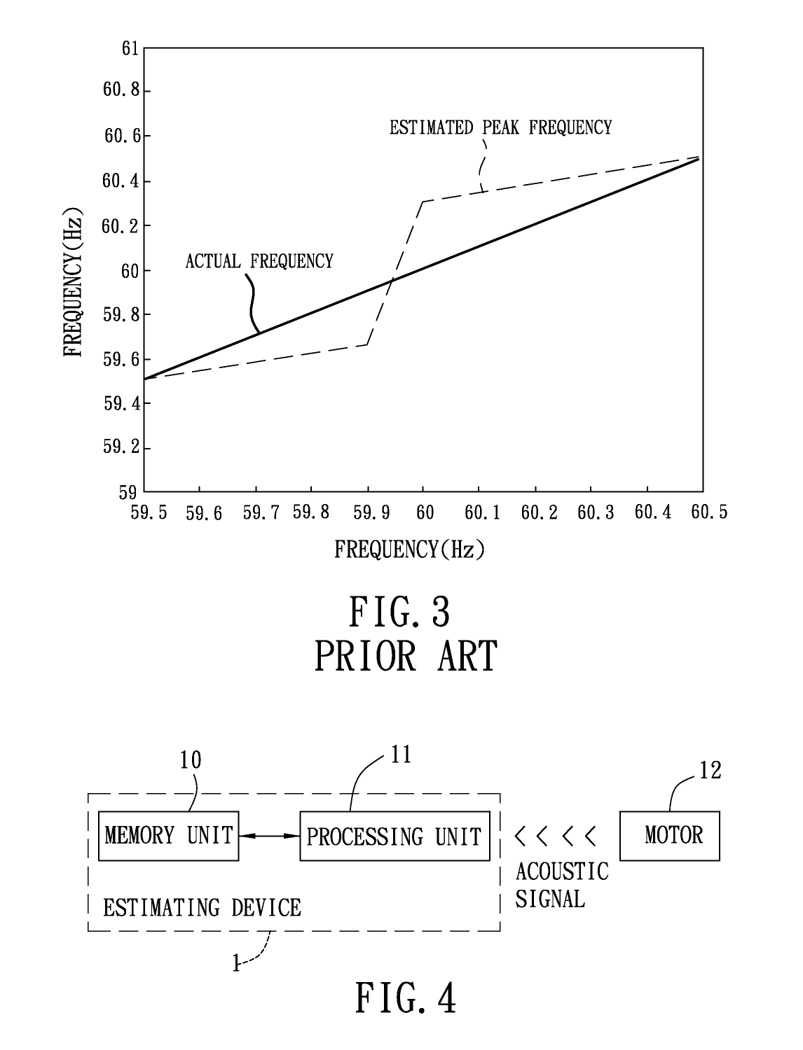

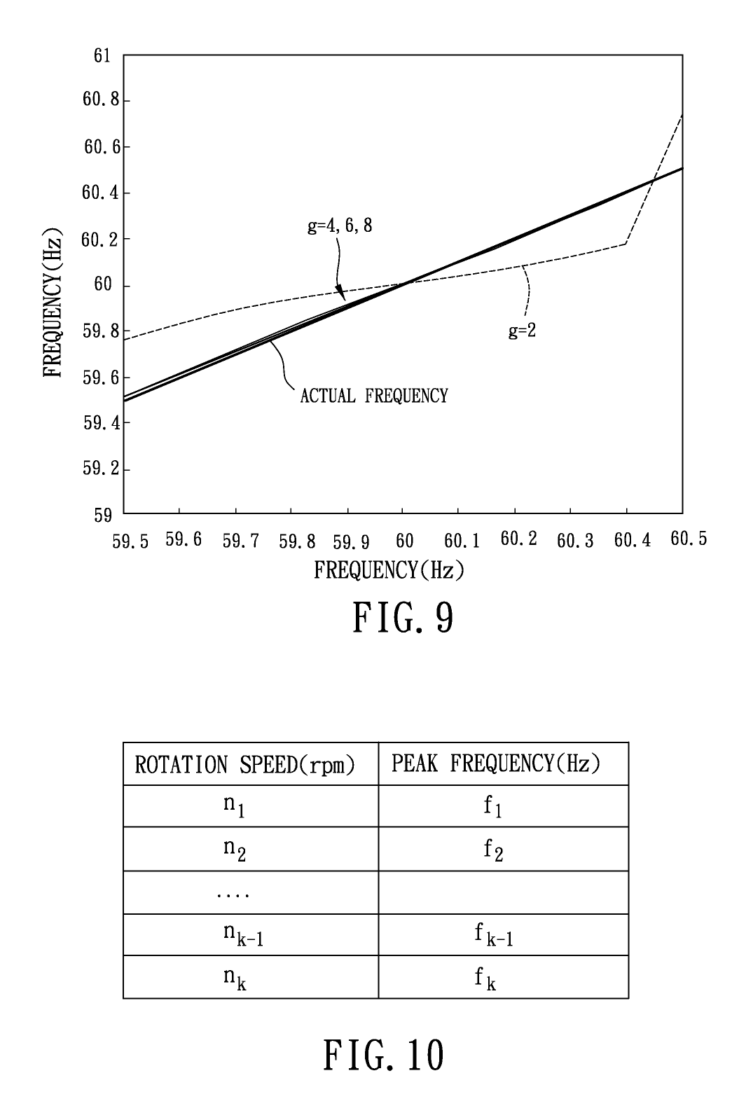

FIG. 9 shows a relationship between the actual frequency and the peak frequency obtained using the centroid method based upon Equations (1) and (2) in step 23. It can be appreciated that the peak frequency is considerably approximate to the actual frequency when the number of the reference sample points in each of the sets is equal to 4, 6 and 8 (g=4, 6, 8). That is, the peak frequency obtained using the centroid method is more accurate than the estimated peak frequency obtained using the second-order polynomial equation in the conventional method (see FIG. 3).

Finally, in step 24, the processing unit 11 is operable to establish a first look-up table containing the known values of the rotation speeds of the motor 12 and the peak frequencies that are computed in step 23 and that correspond to the known values of the rotation speeds, respectively. Then, the processing unit 11 is further operable to store the first look-up table in the memory unit 10. FIG. 10 shows an example of the first look-up table in which n₁ to nₖ are the known values of the rotation speeds and f₁ to fₖ are the peak frequencies corresponding to the known values of the rotation speeds (n₁ to nₖ), respectively.

Referring to FIGS. 4 and 11, during the rotation speed estimation procedure 30 of the method, the processing unit 11 is operable to receive an acoustic signal attributed to operation of the motor 12 in step 31. Subsequently, in step 32, the processing unit 11 is operable to process the acoustic signal to obtain a plurality of sample points in the frequency domain. Each of the sample points has a frequency and an amplitude corresponding to the frequency. In particular, step 32 includes the following sub-steps 321-323 similar to sub-steps 221-223 in the look-up table establishment procedure 20.

In sub-step 321, the processing unit 11 is operable to sample the acoustic signal received in step 31 at the predetermined sampling rate so as to obtain a set of sample data in the time domain. In sub-step 322, the processing unit 11 is operable to transform the set of sample data in the time domain to a spectrum that has a plurality of initial sample points in the frequency domain using FFT. Then, in sub-step 323, the processing unit 11 is operable to select at least a part of the initial sample points obtained in sub-step 322 within a target bandwidth that covers a frequency corresponding to the greatest amplitude in the spectrum (see FIG. 6) as the sample points to be used next.

In step 33, the processing unit 11 is operable to compute an estimated peak frequency using the centroid method based upon the frequency and the amplitude of each of the sample points in the frequency domain obtained in step 32. The processing unit 11 is also configured to compute the estimated peak frequency based upon Equations (1) and (2). It should be noted that, in the rotation speed estimation procedure 30, f_{y} is the estimated peak frequency, g is a number of the sample points in the frequency domain obtained in step 32, P is an index indicating one of the sample points that is associated with the greatest amplitude, A_{P+i} is the amplitude of one of the sample points that corresponds to the index P+i, f_{P+i} is the frequency of one of the sample points that corresponds to the index P+i, and ε is an index that is equal to 1 when A_{P-1}<A_{P+1} and that is equal to −1 when A_{P-1}>A_{P+1}.

In step 34, the processing unit 11 is operable to select, from the first look-up table stored in the memory unit 10, a part of the peak frequencies approximate to the estimated peak frequency computed in step 33 and a corresponding part of the known values of the rotation speeds.

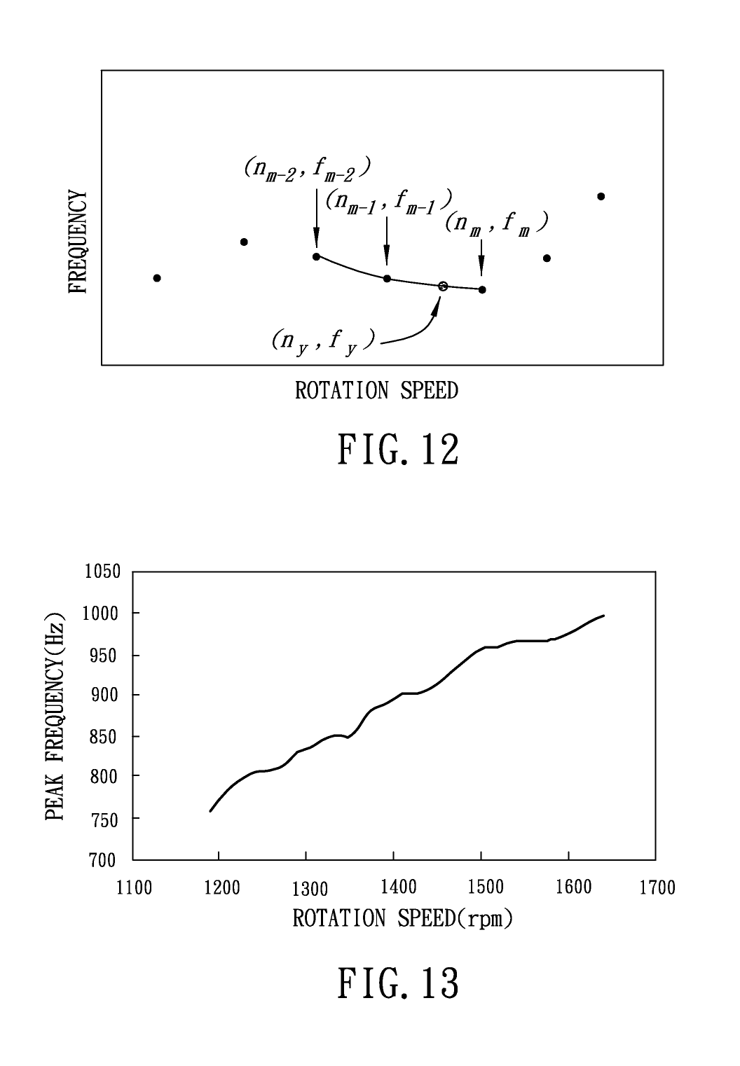

In step 35, the processing unit 11 is operable to compute an estimated value of the rotation speed of the motor 12 using Lagrange interpolation based upon the part of the peak frequencies and the corresponding part of the known values of the rotation speeds selected from the first look-up table in step 34. Referring to FIG. 12, f_{y} is the estimated peak frequency computed in step 33, n_{y} is the estimated value of the rotation speed to be computed in step 35, fₘ to fₘ₋₂ are the peak frequencies that are approximate to the estimated peak frequency f_{y} and that are selected from the first look-up table in step 34, and nₘ, to nₘ₋₂ are the known values of the rotation speeds that are selected from the first look-up table in step 34 and that correspond to the peak frequencies fₘ to fₘ₋₂, respectively. Thus, a Lagrange polynomial used in step 35 can be expressed as Equation (3).

$${n}_{y} = {\sum }_{i = 0}^{2} [ {\prod }_{j = 0 , j \neq i}^{2} \frac{( {f}_{y} - {f}_{m - j} )}{( {f}_{m - i} - {f}_{m - j} )} ] {n}_{m - i} \qquad ( 3 )$$

In Equation (3), n_{y} is the estimated value of the rotation speed, fₘ₋ᵢ and fₘ₋ⱼ are the peak frequencies that are approximate to the estimated peak frequency and that are selected in step 34, and nₘ₋ᵢ is one of the known values of the rotation speed corresponding to the peak frequency fₘ₋ᵢ. FIG. 13 shows a relationship between the estimated peak frequency f_{y} and the estimated value of the rotation speed n_{y} that are computed according to the above-mentioned method.

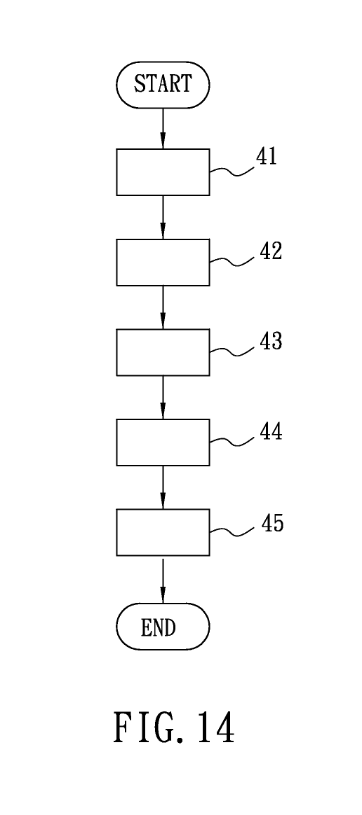

Additionally, referring to FIGS. 4 and 14, the estimating device 1 is further operable to implement a method for estimating the input power provided to the motor 12. The memory unit 10 of the estimating device 1 further stores a second look-up table containing a plurality of known values of the input power provided to the motor 12 and a plurality of peak frequencies corresponding to the known values of the input power, respectively. Since establishment of the second look-up table is similar to the look-up table establishment procedure 20 of the first look-up table as described above with reference to FIG. 5, details thereof will be omitted herein for the sake of brevity.

In step 41 of the method for estimating the input power, the processing unit 11 is operable to receive the acoustic signal attributed to operation of the motor 12. Then, the processing unit 11 is operable to process the acoustic signal to obtain the sample points in the frequency domain in step 42 similar to step 32. Each of the sample points has a frequency and an amplitude corresponding to the frequency.

In step 43, the processing unit 11 is operable to compute the estimated peak frequency using the centroid method based upon the frequency and the amplitude of each of the sample points in the frequency domain obtained in step 42.

In step 44, the processing unit 11 is operable to select, from the second look-up table stored in the memory unit 10, a part of the peak frequencies approximate to the estimated peak frequency computed in step 43 and a corresponding part of the known values of the input power.

In step 45, the processing unit 11 is operable to compute an estimated value of the input power provided to the motor 12 using Lagrange interpolation based upon the part of the peak frequencies and the corresponding part of the known values of the input power selected from the second look-up table in step 44. Similarly, a Lagrange polynomial used in step 45 can be expressed as Equation (4).

$${p}_{y} = {\sum }_{i = 0}^{2} [ {\prod }_{j = 0 , j \neq i}^{2} \frac{( {f}_{y} - {f}_{m - j} )}{( {f}_{m - i} - {f}_{m - j} )} ] {p}_{m - i} \qquad ( 4 )$$

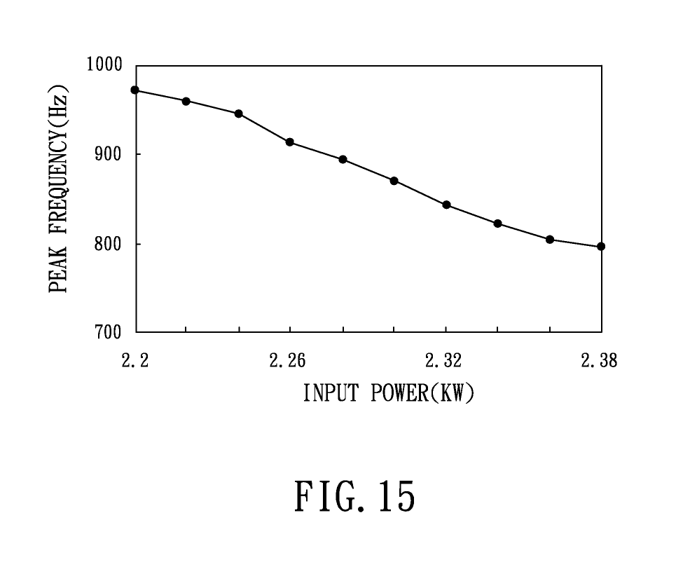

In Equation (4), p_{y} is the estimated value of the input power, f_{y} is the estimated peak frequency computed in step 43, fₘ₋ᵢ and fₘ₋ⱼ are the peak frequencies that are approximate to the estimated peak frequency and that are selected in step 44, and pₘ₋ᵢ is one of the known values of the input power corresponding to the peak frequency fₘ₋ᵢ. FIG. 15 shows a relationship between the estimated peak frequency f_{y} and the estimated value of the input power p_{y} that are computed according to the foregoing method.

In summary, the estimated peak frequency computed using the centroid method is relatively accurate so that the estimated value of the rotation speed of the motor 12 related to the estimated peak frequency thus computed is also relatively accurate. Similarly, the estimated value of the input power provided to the motor 12 is also relatively accurate.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method for estimating an operational parameter of a motor, said method to be implemented by an estimating device and comprising the following steps of:
a) configuring the estimating device to receive an acoustic signal attributed to operation of the motor;
b) configuring the estimating device to process the acoustic signal to obtain a plurality of sample points in the frequency domain, each of which has a frequency and an amplitude corresponding to the frequency;
c) configuring the estimating device to compute an estimated peak frequency using a centroid method based upon the frequency and the amplitude of each of the sample points in the frequency domain obtained in step b);
d) from a plurality of peak frequencies and a plurality of known values of the operational parameter of the motor that correspond respectively to the peak frequencies, configuring the estimating device to select a part of the peak frequencies approximate to the estimated peak frequency and a corresponding part of the known values of the operational parameter; and
e) configuring the estimating device to compute an estimated value of the operational parameter of the motor using interpolation based upon the peak frequencies and the known values of the operational parameter selected in step d).

2. The method as claimed in claim 1, wherein step b) includes the following sub-steps of:
b1) configuring the estimating device to sample the acoustic signal at a predetermined sampling rate so as to obtain a set of sample data in the time domain;
b2) configuring the estimating device to transform the set of sample data in the time domain to a spectrum that has a plurality of initial sample points in the frequency domain using Fast Fourier Transform; and
b3) configuring the estimating device to select at least apart of the initial sample points within a target bandwidth that covers a frequency corresponding to the greatest amplitude in the spectrum as the sample points to be used in step c).

3. The method as claimed in claim 1, wherein, in step c), the estimating device is configured to compute the estimated peak frequency using the centroid method based upon
$$\begin{matrix}{f}_{y} = \frac{{\sum }_{i = - 0.5 g + 1}^{0.5 g} ( {A}_{P + i} ) ( {f}_{P + i} )}{{\sum }_{i = - 0.5 g + 1}^{0.5 g} {A}_{P + i}} , ɛ = 1 \\ {f}_{y} = \frac{{\sum }_{i = - 0.5 g}^{0.5 g + 1} ( {A}_{P + i} ) ( {f}_{P + i} )}{{\sum }_{i = - 0.5 g}^{0.5 g + 1} {A}_{P + i}} , ɛ = - 1\end{matrix}$$
where f_{y} is the estimated peak frequency, g is a number of the sample points in the frequency domain obtained in step b), P is an index indicating one of the sample points that is associated with the greatest amplitude, A_{P+i} is the amplitude of one of the sample points that corresponds to the index P+i, f_{P-i} is the frequency of one of the sample points that corresponds to the index P+i, and ε is an index that is equal to 1 when A_{P-1}<A_{P+1} and that is equal to −1 when A_{P-1}>A_{P+1}.

4. The method as claimed in claim 1, wherein, in step e), the estimating device is configured to compute the estimated value of the operational parameter of the motor based upon
$${n}_{y} = {\sum }_{i = 0}^{2} [ {\prod }_{j = 0 , j \neq i}^{2} \frac{( {f}_{y} - {f}_{m - j} )}{( {f}_{m - i} - {f}_{m - j} )} ] {n}_{m - i} ,$$
where n_{y} is the estimated value of the operational parameter, f_{y} is the estimated peak frequency computed in step c), fₘ₋ᵢ and fₘ₋ⱼ are the peak frequencies that are approximate to the estimated peak frequency and that are selected in step d), and nₘ₋ᵢ is one of the known values of the operational parameter corresponding to the peak frequency fₘ₋ᵢ.

5. The method as claimed in claim 1, further comprising, prior to step a), the steps of:
a1) configuring the estimating device to receive a plurality of reference acoustic signals attributed to operation of the motor with the known values of the operational parameter, respectively;
a2) configuring the estimating device to process the reference acoustic signals to obtain plural sets of reference sample points in the frequency domain, each of the reference sample points in each of the sets having a frequency and an amplitude corresponding to the frequency;
a3) configuring the estimating device to compute the peak frequencies using the centroid method based upon the sets of the reference sample points obtained in step a2), respectively; and
a4) configuring the estimating device to establish and store a look-up table containing the known values of the operational parameter and the peak frequencies corresponding to the known values of the operational parameter, respectively;
wherein, in step d), the estimating device is configured to select said part of the peak frequencies and said corresponding part of the known values of the operational parameter from the look-up table established in step a4).

6. The method as claimed in claim 1, wherein the operational parameter of the motor is a rotation speed of the motor, and the estimated value computed in step e) is an estimated rotation speed of the motor during operation.

7. The method as claimed in claim 1, wherein the operational parameter of the motor is an input power provided to the motor, and the estimated value computed in step e) is an estimated input power provided to the motor during operation.

8. The method as claimed in claim 1, the estimating device including a memory unit storing a look-up table that contains the peak frequencies and the known values of the operational parameter of the motor,
wherein, in step d), the estimating device is configured to select said part of the peak frequencies and said corresponding part of the known values of the operational parameter from the look-up table stored in the memory unit.

9. An estimating device for estimating an operational parameter of a motor, said estimating device comprising:
a memory unit storing a look-up table that contains a plurality of peak frequencies and a plurality of known values of the operational parameter of the motor corresponding to the peak frequencies, respectively; and
a processing unit electrically connected to said memory unit, said processing unit being operable to implement an estimation method including the following steps of
i) receiving an acoustic signal attributed to operation of the motor,
ii) processing the acoustic signal to obtain a plurality of sample points in the frequency domain, each of which has a frequency and an amplitude corresponding to the frequency,
iii) computing an estimated peak frequency using a centroid method based upon the frequency and the amplitude of each of the sample points in the frequency domain obtained in step ii),
iv) from the look-up table stored in the memory unit, selecting a part of the peak frequencies approximate to the estimated peak frequency and a corresponding part of the known values of the operational parameter, and
v) computing an estimated value of the operational parameter of the motor using interpolation based upon the peak frequencies and the known values of the operational parameter selected in step iv).

10. The estimating device as claimed in claim 9, wherein, in step ii) of the estimation method, said processing unit is operable to:
sample the acoustic signal at a predetermined sampling rate so as to obtain a set of sample data in the time domain;
transform the set of sample data in the time domain to a spectrum that has a plurality of initial sample points in the frequency domain using Fast Fourier Transform; and
select at least a part of the initial sample points within a target bandwidth that covers a frequency corresponding to the greatest amplitude in the spectrum as the sample points to be used in step iii).

11. The estimating device as claimed in claim 9, wherein, in step iii) of the estimation method, said processing unit is operable to compute the estimated peak frequency using the centroid method based upon
$$\begin{matrix}{f}_{y} = \frac{{\sum }_{i = - 0.5 g + 1}^{0.5 g} ( {A}_{P + i} ) ( {f}_{P + i} )}{{\sum }_{i = - 0.5 g + 1}^{0.5 g} {A}_{P + i}} , ɛ = 1 \\ {f}_{y} = \frac{{\sum }_{i = - 0.5 g}^{0.5 g + 1} ( {A}_{P + i} ) ( {f}_{P + i} )}{{\sum }_{i = - 0.5 g}^{0.5 g + 1} {A}_{P + i}} , ɛ = - 1\end{matrix}$$
where f_{y} is the estimated peak frequency, g is a number of the sample points in the frequency domain obtained in step ii), P is an index indicating one of the sample points that is associated with the greatest amplitude, A_{P+i} is the amplitude of one of the sample points that corresponds to the index P+i, f_{P-i} is the frequency of one of the sample points that corresponds to the index P+i, and ε is an index that is equal to 1 when A_{P-1}<A_{P+1} and that is equal to −1 when A_{P-1}>A_{P+1}.

12. The estimating device as claimed in claim 9, wherein, in step v) of the estimation method, said processing unit is operable to compute the estimated value of the operational parameter of the motor based upon
$${n}_{y} = {\sum }_{i = 0}^{2} [ {\prod }_{j = 0 , j \neq i}^{2} \frac{( {f}_{y} - {f}_{m - j} )}{( {f}_{m - i} - {f}_{m - j} )} ] {n}_{m - i} ,$$
where n_{y} is the estimated value of the operational parameter, f_{y} is the estimated peak frequency computed in step iii), fₘ₋ᵢ and fₘ₋ⱼ are the peak frequencies that are approximate to the estimated peak frequency and that are selected in step iv), and nₘ₋ᵢ is one of the known values of the operational parameter corresponding to the peak frequency fₘ₋ᵢ.

13. The estimating device as claimed in claim 9, wherein said processing unit is further operable, prior to step i), to:
receive a plurality of reference acoustic signals attributed to operation of the motor with the known values of the operational parameter, respectively;
process the reference acoustic signals to obtain plural sets of reference sample points in the frequency domain, each of the reference sample points in each of the sets having a frequency and an amplitude corresponding to the frequency;
compute the peak frequencies using the centroid method based upon the sets of the reference sample points, respectively; and
according to the known values of the operational parameter and the peak frequencies thus computed, establish and store the look-up table in said memory unit.

14. The estimating device as claimed in claim 9, wherein the operational parameter of the motor is a rotation speed of the motor, and said processing unit is operable, in step iv), to compute the estimated value as an estimated rotation speed of the motor during operation.

15. The estimating device as claimed in claim 9, wherein the operational parameter of the motor is an input power provided to the motor, and said processing unit is operable, in step iv), to compute the estimated value computed as an estimated input power provided to the motor during operation.
